(19) United States
(12) Patent Application Publication
(10) Pub. No.: US 2013/0098450 A1
(43) Pub. Date: Apr. 25, 2013

(54) Methods, Devices, and Systems for Laundry Fluid Delivery

(71) Applicant: Dustin Frantz, Post Falls, ID (US)

(72) Inventor: Dustin Frantz, Post Falls, ID (US)

(21) Appl. No.: 13/277,428

(22) Filed: Oct. 20, 2011

(51) Int. Cl. F15D 1/00

(52) U.S. Cl. 137/1; 137/551; 137/565.01

(57) ABSTRACT

Methods, devices, and systems for laundry fluid delivery are disclosed. A laundry fluid delivery controller includes a user interface configured to receive input from a user regarding use of a laundry fluid in a washing machine, a pump configured to pump the laundry fluid from a fluid reservoir to the washing machine, and processing circuitry configured to control the pump in response to the user input and to operate independent of any control circuitry of the washing machine, the control circuitry being configured to control operation of the washing machine.

### TECHNICAL FIELD

The present invention, in various embodiments, relates to laundry fluid delivery.

### BACKGROUND OF THE INVENTION

In a facility having several washing machines operated by staff or residents of the facility, many issues arise with respect to the use of the washing machines. Such facilities include managed care facilities where staff wash many loads of laundry each day, typically in four or five consumer-sized washing machines rather than large commercial washing machines. One issue is that those who use the washing machines may put too much or too little detergent into the washing machine when washing a load of laundry. If too little detergent is used, the laundry might not get clean. On the other hand, using too much detergent may damage or unnecessarily wear the laundry and/or the washing machine. Another issue is that those who have access to the laundry room may steal laundry detergent belonging to the facility and intended for use in the facility, especially if the detergent is in powdered form. In addition to these issues, there is a general need to collect data related to the quantity and timing of laundry loads washed in the facility.

### BRIEF DESCRIPTION OF THE DRAWINGS

Preferred embodiments of the invention are described below with reference to the following accompanying drawings.

FIG. 1 illustrates a system for laundry fluid delivery according to an embodiment.

FIG. 1A illustrates positioning of conduits in a top-loading washing machine according to an embodiment.

FIG. 2 illustrates positioning of conduits in a front-loading washing machine according to an embodiment.

FIG. 3 illustrates a laundry fluid delivery controller according to an embodiment.

FIG. 4 illustrates a laundry fluid reservoir and wand according to an embodiment.

FIG. 5 is a block diagram of a laundry fluid delivery controller according to an embodiment.

FIG. 6 is a block diagram of a system for communicating data according to an embodiment.

### DETAILED DESCRIPTION OF THE PREFERRED EMBODIMENTS

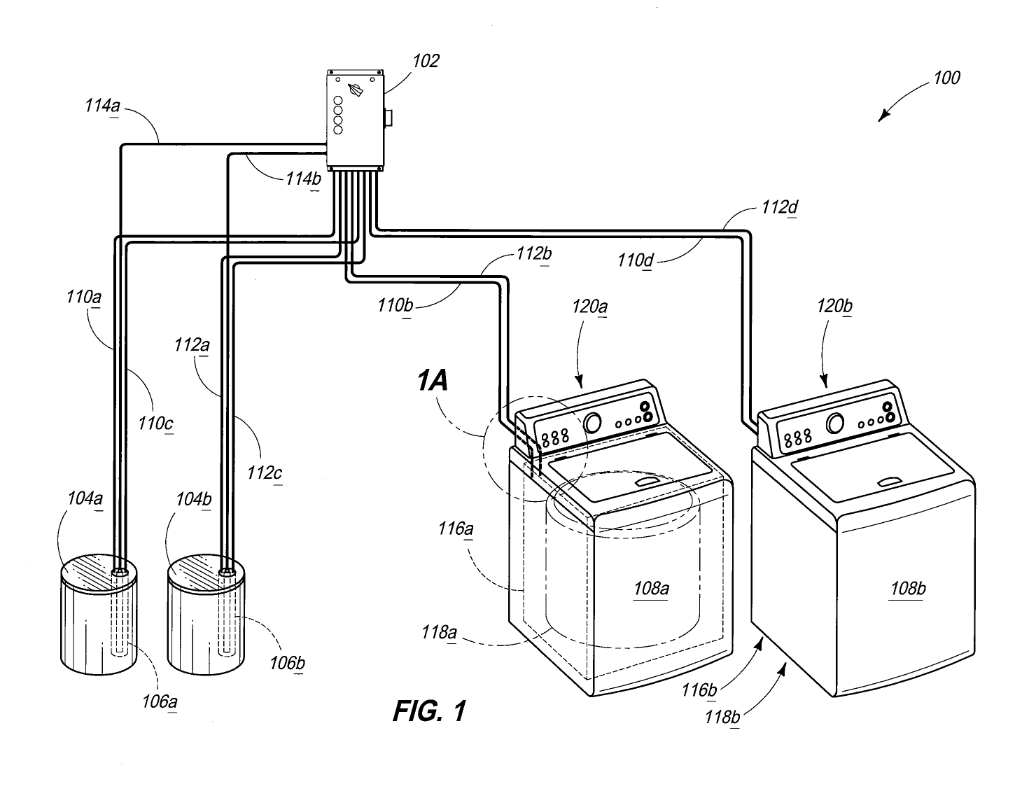

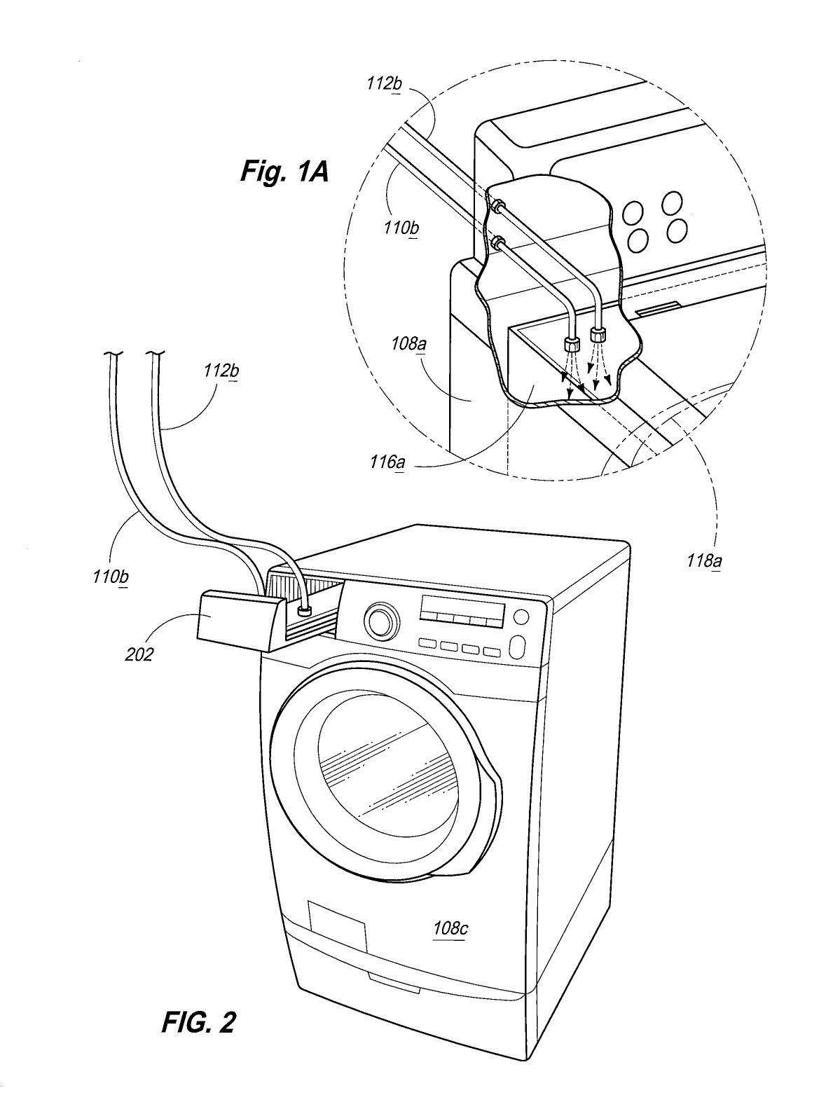

In a facility having several washing machines operated by staff or residents of the facility, such as a managed care facility, a system may be installed that automatically deposits the correct amount of laundry detergent, bleach, and/or other laundry liquid into a washing machine at the beginning and/or during a wash cycle. Referring to FIG. 1, such a system 100 is illustrated. System 100 includes laundry fluid reservoirs 104a and 104b, which store laundry fluids, such as liquid laundry detergent and liquid bleach, washing machines 108a and 108b, and a laundry fluid delivery controller 102. System 100 also includes conduits 110 and 112 connecting reservoirs 104, controller 102, and washing machines 108 as illustrated in FIG. 1. Conduits 110 and 112 may be flexible plastic tubes in one embodiment.

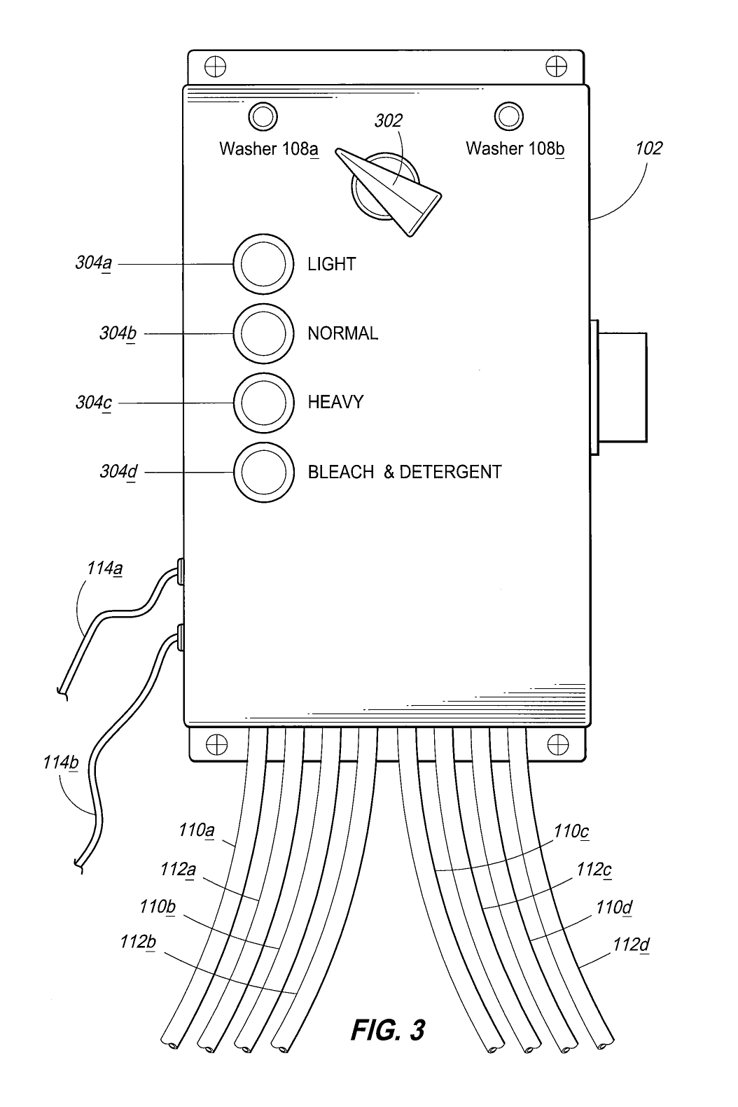

In one example, reservoir 104a stores liquid detergent and reservoir 104b stores liquid bleach. Controller 102 includes a user interface (illustrated in detail in FIG. 3) allowing a user to request that a laundry fluid (e.g., liquid laundry detergent, liquid bleach, etc.) be deposited in a washing machine 108a and/or washing machine 108b. The user interface may also allow the user to specify the amount of laundry liquid to be deposited. For example, in one embodiment the user interface may include push buttons allowing a user to select from among a light load, normal load, heavy load, and detergent plus bleach load. If the light load button 304a (see FIG. 3) is pressed and washing machine 108a is selected using knob 302, controller 102 pumps a predetermined amount of liquid detergent that is appropriate for washing a load of laundry that is significantly less than the capacity of washing machine 108a (e.g., a load that is half the capacity of the washing machine) from reservoir 104a to washing machine 108a via conduits 110a and 110b.

If the normal load button 304b is pressed, controller 102 pumps a predetermined amount of liquid detergent that is appropriate for washing a load of laundry that is at or just below the capacity of washing machine 108a from reservoir 104a to washing machine 108a via conduits 110a and 110b. If the heavy load button 304c is selected, controller 102 delivers a predetermined amount of liquid detergent that is appropriate for washing a load of laundry that is at the capacity of washing machine 108a or a load that is heavily soiled from reservoir 104a to washing machine 108a via conduits 110a and 110b.

If button 304d is pressed, controller 102 delivers a predetermined amount of liquid detergent that is appropriate for washing a load of laundry that is at or just below the capacity of washing machine 108a from reservoir 104a to washing machine 108a via conduits 110a and 110b. Controller 102 also delivers a predetermined amount of liquid bleach from reservoir 104b to washing machine 108a via conduits 112a and 112b. Other buttons or input devices are possible that deliver other amounts of one or more laundry fluids. The buttons of FIG. 3 are provided by way of example.

Of course, if washing machine 108b is selected using knob 302, controller 102 may deliver liquid detergent to washing machine 108b via conduits 110c and 110d. Furthermore, controller 102 may deliver liquid bleach to washing machine 108b via conduits 112c and 112d.

In one embodiment, controller 102 may include one or more pumps that pump laundry fluid from reservoirs 104. Controller 102 may enable the pumps for a predetermined amount of time, may meter the amount of laundry fluid pumped by the pumps and disable the pumps once a predetermined amount of the laundry liquid has been pumped, or use some other method to ensure a predetermined, precise, and consistent amount of laundry fluid is delivered to washing machines 108.

In system 100, controller 102 includes four different pumps, one that pumps laundry fluid from conduit 110a to conduit 110b, one that pumps laundry fluid from conduit 110c to conduit 110d, one that pumps laundry fluid from conduit 112a to conduit 112b, and one that pumps laundry fluid from conduit 112c to conduit 112d. Other embodiments are also possible using more or fewer pumps.

Washing machines 108 include control circuitry 120, which may be conventional control circuitry that conducts a washing machine cycle by controlling aspects of the operation of the washing machine such as: allowing water to flow into a tub 116 of the washing machine, adjusting the temperature of the water, spinning basket 118, emptying tub 116, and so on. Control circuitry 120 may include conventional knobs and buttons used to operate washing machines 108.

In one embodiment, controller 102 operates independent of washing machines 108 and in particular operates independent of any control circuitry 120 of washing machines 108 since controller 102 need not be in communication with control circuitry 120. For example, when a user initiates a washing machine cycle using control circuitry 120a of washing machine 108a, control circuitry 120a does not communicate with controller 102 to instruct controller 102 to deposit laundry fluid in washing machine 118a.

In this embodiment, system 100 relies on a user to initiate the washing machine cycle using control circuitry 120a and, either shortly after or just prior to initiating the washing machine cycle, to use controller 102 to deposit laundry fluid in washing machine 108a. Since controller 102 operates independent of control circuitry 120a, it is possible for a user to deposit laundry fluid in washing machine 108a using controller 102 even though a washing machine cycle of washing machine 108a has not been initiated. Thus, successful operation of system 100, in this embodiment, includes a user both initiating a washing machine cycle using control circuitry 120a and the user depositing laundry fluid in a desired washing machine 108a using controller 102.

Another way of stating the relationship between controller 102 and control circuitry 120 is to say that controller 102 operates without coordinating its operations with control circuitry 120. Yet another way of stating this relationship is to say that controller 102 is configured to be unaware of control circuitry 120, since it is not in communication with control circuitry 120. Yet another way of stating this relationship is to say that controller 102 is oblivious with respect to control circuitry 120. This relationship enables existing washing machines to be retrofitted for use with controller 102. This is advantageous because a business owner who already has washing machines may want to implement system 100 without having to purchase new washing machines.

In one embodiment, controller 102 is configured to deposit the laundry fluid in tubs 116 of washing machines 108 undiluted, as opposed to mixing the laundry fluid with water prior to depositing the laundry fluid in tubs 116. This is accomplished by positioning conduits 110b, 110d, 112b, and 112d so that they deposit laundry fluid directly into tubs 116. Positioning these conduits may involve making slight modifications to washing machines 108 such as drilling holes in the backs of washing machines 108 and passing the conduits through the holes. However, such modifications need not involve modifying the hot or cold water connections made to washing machines 108 by mixing the laundry fluid in with the hot or cold water prior to the water entering washing machines 108.

FIG. 1 illustrates a tub 116a of washing machine 108a and a basket 118a within tub 116a. In operation, clothing is loaded into basket 118a and one or more motors of washing machine 108a spin basket 118a. Tub 116a is configured to contain water. Perforations in basket 118a allow the water in tub 116a to flow into the interior of basket 118a. Unlike basket 118a, typically tub 116a does not rotate.

In one embodiment, each pump of controller 102 includes at least one one-way valve allowing fluid to flow one direction but preventing the fluid from flowing the opposite direction. For example, two directionally aligned one-way valves of controller 102 may allow laundry fluid to flow from conduit 110a to conduit 110b but may prevent fluid from flowing from conduit 110b to conduit 110a. One of the one-way valves may be associated with an input to the pump and the other of the one-way valves may be associated with the output of the pump.

In one embodiment, reservoirs 104 are positioned below tubs 116. Doing so may prevent laundry fluid from being siphoned from reservoirs 104 through conduits 110 and 112 to tubs 116. In particular, siphoning from reservoir 104a through conduit 110a and conduit 110b to tub 116a may be prevented by such positioning. In other embodiments, anti-siphon devices may be included in system 100 to prevent such siphoning, yet allow reservoirs 104 to be positioned at the same level as tubs 116 or higher than tubs 116.

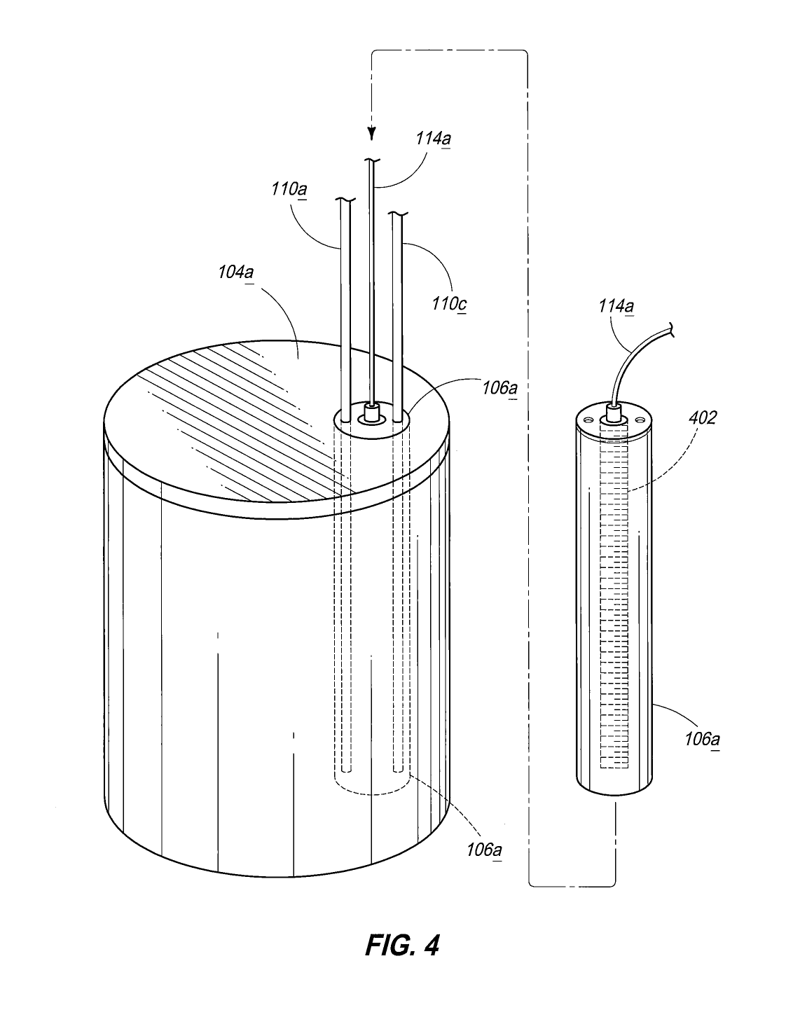

System 100 further includes electrical connections 114. Electrical connection 114a connects wand 106a with controller 102 and electrical connection 114b connects wand 106b with controller 102. Electrical connections 114 enable controller 102 to determine the amount of laundry fluid in reservoirs 104 from time to time as described below in more detail with respect to FIG. 4.

Referring to FIG. 1A, an enlarged portion of FIG. 1 is illustrated depicting conduits 110b and 112b passing through a back wall of washing machine 108a and terminating within washing machine 108a between tub 116a and basket 118a. In this position, conduits 110b and 112b deposit laundry fluid into tub 116a and are not disturbed by the rotation of basket 118a. Note that washing machine 108a might not be specifically designed to accommodate conduits 110b and 112b. However, washing machine 108a may be easily modified to accommodate the conduits by drilling small holes in the back of washing machine 108a. Accordingly, existing washing machines may be retrofitted to accommodate conduits 110b and 112b.

Referring to FIG. 2, a front-loading washing machine 108c is illustrated. Washing machine 108c includes detergent receptacle 202. As illustrated, washing machine 108c may be retrofitted to accommodate conduits 110b and 112b by positioning the conduits within detergent receptacle 202 and attaching them to washing machine 108c. Once retrofitted in this manner, frontloading washing machines may be used in system 100 in addition to, or in place of, top-loading washing machines 108a and 108b.

Referring to FIG. 3, a detailed depiction of controller 102 is illustrated including knob 302 and buttons 304 described above. In addition, electrical connections 114a and 114b are illustrated as well as conduits 110 and 112. In one embodiment, controller 102 may be sold or distributed without electrical connections 114 or conduits 112 and 110. At installation, electrical connections 114 may be interfaced with controller 102, for example via connectors of controller 102, and conduits 110 and 112 may be interfaced to controller 102 using, for example, tubular connectors configured to fit snugly within conduits 110 and 112 and retain conduits 110 and 112 in place. Such connectors may be referred to as conduit interfaces.

Referring to FIG. 4, reservoir 104a and wand 106a are illustrated. Note that reservoir 104a includes a lid through which wand 106a passes. The lid may act as a theft deterrent preventing users or others from easily stealing laundry fluid from reservoir 104a. In one embodiment, the lid may be secured to the body of reservoir 104a using a theft deterring mechanism such as a lock or screws.

Wand 106a comprises a measuring device 402 that provides an electrical signal indicating the level of the laundry fluid within reservoir 104a. Electrical connection 114a conveys the signal to controller 102, which may use the signal to determine the amount of laundry fluid remaining within reservoir 104a. In one embodiment, measuring device 402 is a hydrostatic pressure sensitive device that senses liquid level by hydrostatic pressure exerted against measuring device 402 by the laundry fluid. Wand 106a may be perforated to allow laundry fluid and air within reservoir 104a to freely flow within wand 106a. Wand 106a also includes holes through which conduits 110a and 110c pass.

Using wand 106a may be advantageous because it provides a convenient, protected location in which measuring device 402 and conduits 110a and 110c may be mounted. Once reservoir 104a has been depleted, an operator may remove wand 106a from reservoir 104a, replace reservoir 104a with a new full reservoir, and insert wand 106a into the new full reservoir. In this manner, wand 106a may be reused with many different reservoirs over time.

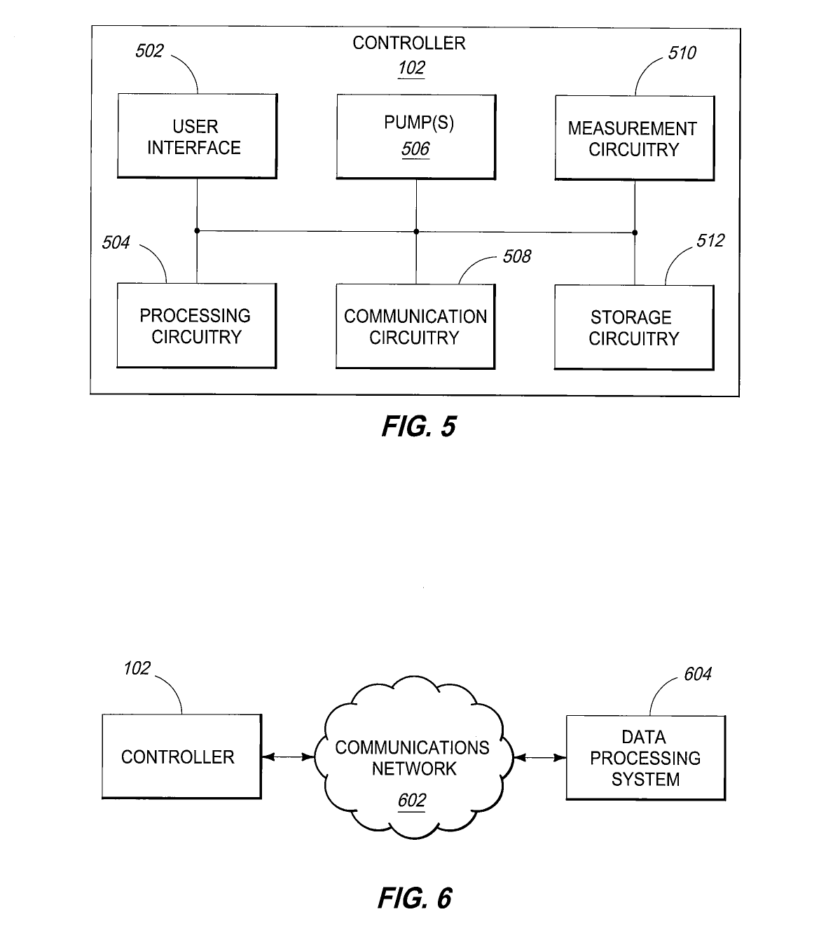

FIG. 5 illustrates a block diagram of controller 102. Controller 102 includes user interface 502, processing circuitry 504, pump(s) 506, communication circuitry 508, measurement circuitry 510, and storage circuitry 512.

User interface 502 allows a user to instruct controller 102 to perform a particular function, such as depositing an amount of liquid detergent adequate for a light load of laundry in a washing machine. In one embodiment, user interface 502 includes knob 302 and buttons 304 of FIG. 3. Other embodiments are also possible.

In general, user interface 502 may be configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface may include a display (e.g., cathode ray tube, LCD, etc.) configured to depict visual information and an audio system as well as a keyboard, mouse, push buttons, knobs, and/or other input device. Any other suitable apparatus for interacting with a user may also be utilized.

Pump(s) 506 have been described in detail above. In general, pumps 506 pump laundry fluid from one conduit interface of controller 102 to another conduit interface of controller 102. When conduits are attached to the conduit interfaces, pumps 506 pump laundry fluid from a fluid reservoir to a washing machine. As was mentioned above, controller 102 may include a single pump, for example in an application in which controller 102 is used with a single washing machine to provide a single laundry fluid, or controller 102 may include multiple pumps, for example in an application in which controller 102 is used with multiple washing machines and multiple laundry fluids. Each pump may include one or more one-way valves to prevent fluid from flowing from a washing machine into a fluid reservoir.

Processing circuitry 504 may comprise circuitry configured to implement desired programming provided by appropriate media in at least one embodiment. For example, processing circuitry 504 may be implemented as one or more of a processor and/or other structure configured to execute executable instructions including, for example, software and/or firmware instructions, and/or hardware circuitry. Exemplary embodiments of processing circuitry 504 include hardware logic, PGA, FPGA, ASIC, state machines, and/or other structures alone or in combination with a processor. These examples of processing circuitry 504 are for illustration and other configurations are possible.

Storage circuitry 512 may be embodied in a number of different ways using electronic, magnetic, optical, electromagnetic, or other techniques for storing information. Some specific examples of storage circuitry include, but are not limited to, a portable magnetic computer diskette, such as a floppy diskette, zip disk, hard drive, random access memory, read only memory, flash memory, cache memory, and/or other configurations capable of storing programming, data, or other digital information. In one embodiment, storage circuitry 512 may store programming implemented by processing circuitry 512.

At least some embodiments or aspects described herein may be implemented using programming stored within appropriate processor-usable media such as storage circuitry 512 and/or communicated via a network or other transmission media and configured to control appropriate processing circuitry. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure or medium. Exemplary programming including processor-usable code may be communicated as a data signal embodied in a carrier wave in but one example. Said another way, controller 102 may include processing circuitry 504 that executes programming (i.e., software or firmware) stored by storage circuitry 512.

Measurement circuitry 510 is configured to determine an amount of laundry fluid present in a fluid reservoir. In one embodiment, measurement circuitry 510 may be connected to measuring device 402 via electrical connection 114a and may use information provided by measuring device 402 to determine the amount of laundry fluid present in the fluid reservoir. Other techniques are also possible in which measurement circuitry 510 determines an amount of laundry fluid present in a fluid reservoir.

Communication circuitry 508 is configured to communicate with devices external to controller 102. For example, communication circuitry 508 may be a wired or wireless Ethernet interface enabling processing circuitry 504 to communicate via a network (e.g., the Internet) with other data processing devices. Such a network is illustrated in FIG. 6, which depicts controller 102 connected to communications network 602 and data processing system 604 also connected to communications network 602. In one embodiment, processing circuitry 504 may use communication circuitry 508 to communicate data stored in storage circuitry 512 to data processing system 604 via communications network 602. Additionally or alternatively, processing circuitry 504 may receive instructions and/or data from data processing system 604 via communication circuitry 508 and communications network 602.

Several methods of using system 100 will now be described. According to one embodiment, processing circuitry 504 receives and processes input from user interface 502 and operates pump(s) 506 based on the input. Processing circuitry 504 also collects data related to the use of controller 102 and makes the data accessible to devices outside of the system via communication circuitry 508. Processing circuitry 504 may, for example, collect data related to each use of controller 102 such as the day and time (e.g., a timestamp) of the use and the setting (e.g., light, normal, heavy) selected for each use. This data may effectively log the timing and number of loads of laundry washed in the facility by recording information about the consumption of the laundry fluid. Processing circuitry 504 may provide data that it collects to other systems (e.g., data processing system 604) via communication circuitry 508.

According to one method, controller 102 receives input from a user related to an amount of laundry fluid to be deposited in a washing machine 108. In response, controller 102 pumps, or otherwise conveys, a predetermined amount of laundry fluid from a reservoir 104 to the washing machine. Controller 102 also logs information regarding the deposit of the laundry fluid. For example, controller 102 may record data regarding each usage of controller 102. In other words, for each iteration of use of controller 102, controller 102 may store data regarding that iteration. Controller 102 may record data describing the date and time that the laundry liquid was conveyed, data identifying the washing machine to which the laundry liquid was conveyed, and the amount of laundry liquid that was pumped (which may be determined, for example, based on which button 304 was pressed e.g., light, normal, heavy, etc.).

Controller 102 may record other data as well. For example, in one embodiment, controller 102 may ask a user to identify himself, via user interface 502, prior to the user requesting that controller 102 deposit laundry fluid into a washing machine. In this embodiment, controller 102 may record data indicating who originated the request to deposit laundry fluid using controller 102.

In one embodiment, an assumption is made that each time a user uses controller 102 to deposit laundry fluid into a washing machine, the user also initiates a washing machine cycle on that washing machine. Based on this assumption, data gathered by controller 102 regarding, for example, the number of times controller 102 has deposited laundry fluid into a washing machine, the dates and times when such deposits occurred, and the user who initiated the deposits, may be used to infer data regarding the washing machine.

Such data may include the number of cycles a washing machine has completed, the dates and times when such cycles occurred, and the user who initiated the cycles. The data described above may be especially useful to an operator of a facility in which system 100 is installed because it may help the operator predict future laundry fluid expenses, maintenance expenses, and other expenses. Furthermore, the data may help the operator determine that some wash cycles are unnecessary or wasteful and may help the operator create an optimized schedule for when the washing machines are to be used, and so on.

As was described above, controller 102 may provide such data to a data processing system 604 via communications network 602. Data processing system 604 may then analyze and or otherwise extract valuable information from the data and provide the data to an operator of the facility and/or to others.

According to another method, a first entity, such as an equipment vendor, purchases laundry fluid and provides the laundry fluid to a laundry facility at its own expense. A second entity, such as the operator of the laundry facility, uses controller 102 in washing loads of laundry. As was described above, controller 102 logs information regarding the consumption of the laundry fluid as described above. The first entity collects the logged information and uses the logged information to bill the second entity for laundry fluid consumed from the reservoir. The first entity also provides information to the second entity regarding the usage of controller 102 such as the data described above. The first entity may charge the second entity a fee for the information.

System 100 provides a number of benefits. For example, controller 102 delivers a consistent, correct amount of laundry fluid to a washer 108. This alleviates the problems that arise when users put too much laundry detergent in a washing machine and thereby prematurely wear the laundry or washing machine and the problems that arise when user put too little laundry detergent in a washing machine thereby not fully cleaning the laundry. System 100 also prevents theft of laundry detergent by using liquid detergent, which is harder to steal, and by utilizing a reservoir that prevents or severely limits access to laundry liquid in a laundry liquid reservoir.

Furthermore, system 100 provides a facility operator or other entity with detailed information regarding usage of controller 102 to deposit laundry fluids and thereby provides detailed information regarding usage of washing machines. System 100 also enables a business model in which one entity may deliver laundry fluid to a facility operated by a second entity and may then charge the second entity for an amount of the laundry fluid used, thereby freeing the second entity from having to purchase and transport the laundry fluid.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A laundry fluid delivery controller comprising:
a user interface configured to receive input from a user regarding use of a laundry fluid in a washing machine;
a pump configured to pump the laundry fluid from a fluid reservoir to the washing machine; and
processing circuitry configured to control the pump in response to the user input and to operate independent of any control circuitry of the washing machine, the control circuitry being configured to control operation of the washing machine.

2. The controller of claim 1 wherein the processing circuitry is configured to operate without coordinating with the control circuitry of the washing machine.

3. The controller of claim 1 wherein the processing circuitry is configured to be unaware of the control circuitry of the washing machine.

4. The controller of claim 1 wherein the controller is configured to deliver the laundry fluid undiluted to a tub of the washing machine.

5. The controller of claim 1 further comprising storage circuitry configured to store data regarding operations completed by the processing circuitry.

6. The controller of claim 5 wherein the data includes data regarding usage of the controller to pump the laundry fluid.

7. The controller of claim 5 wherein the data includes data regarding an amount of laundry fluid remaining in the fluid reservoir.

8. The controller of claim 5 further comprising communication circuitry configured to communicate the stored data to a data processing system via a communications network.

9. The controller of claim 1 further comprising at least two conduit interfaces, and wherein the pump is configured to draw a predetermined amount of the laundry fluid from a first one of the conduit interfaces and deliver the predetermined amount of the laundry fluid to a second one of the conduit interfaces.

10. The controller of claim 9 further comprising an additional pump configured to pump the laundry fluid from the fluid reservoir to an additional washing machine via a third one of the conduit interfaces and a fourth one of the conduit interfaces.

11. The controller of claim 9 further comprising an additional pump configured to pump a second laundry fluid from a second fluid reservoir to the washing machine via a third one of the conduit interfaces and a fourth one of the conduit interfaces.

12. The controller of claim 1 wherein the pump comprises two directionally aligned one-way valves configured to allow the laundry fluid to flow from the fluid reservoir to the washing machine and configured to prevent fluid from flowing from the washing machine to the fluid reservoir.

13. The controller of claim 1 further comprising measurement circuitry configured to determine an amount of laundry fluid in the fluid reservoir from time to time.

14. The controller of claim 1 wherein the laundry fluid is laundry detergent.

15. The controller of claim 1 wherein the user input indicates an amount of the laundry fluid to be delivered to the washing machine.

16. A laundry fluid delivery method comprising:
receiving input from a user regarding use of a laundry fluid in a washing machine; and
independent of any control circuitry of the washing machine, automatically pumping a predetermined amount of the laundry fluid into a tub of the washing machine from a fluid reservoir external to the washing machine in response to the user input, the control circuitry of the washing machine being configured to control operation of the washing machine.

17. The method of claim 16 further comprising:
iterating the method of claim 16 multiple times; and
for each iteration, storing data regarding the iteration.

18. The method of claim 17 wherein the data comprises a time stamp related to when the iteration took place.

19. A method comprising:
a first entity providing a laundry fluid delivery controller for use by a second entity, the laundry fluid delivery controller comprising:
a user interface configured to receive input from a user regarding use of a laundry fluid in a washing machine;
a pump configured to pump the laundry fluid from a fluid reservoir to the washing machine; and
processing circuitry configured to control the pump in response to the user input and to operate independent of any control circuitry of the washing machine, the control circuitry being configured to control operation of the washing machine;
using the laundry fluid delivery controller, recording data regarding the second entity's usage of the laundry fluid delivery controller; and
based on the recorded data, the first entity providing the second entity with information regarding the second entity's usage of the laundry fluid delivery controller.

20. The method of claim 19 further comprising:
the first entity providing laundry fluid within the fluid reservoir;
using the laundry fluid delivery controller, determining an amount of the laundry fluid consumed by the laundry fluid delivery controller during a period; and
the first entity billing the second entity for the consumed laundry fluid.

21. A laundry fluid delivery system comprising:
a laundry fluid delivery controller;
a first washing machine;
a second washing machine;
a laundry fluid reservoir;
a first conduit connecting the laundry fluid reservoir to the laundry fluid delivery controller;
a second conduit connecting the laundry fluid reservoir to the laundry fluid delivery controller;
a third conduit connecting the laundry fluid delivery controller to the first washing machine; and
a fourth conduit connecting the laundry fluid delivery controller to the second washing machine;
wherein the laundry fluid delivery controller is configured to pump laundry fluid from the laundry fluid reservoir to the first washing machine via the first conduit and the third conduit and to pump laundry fluid from the laundry fluid reservoir to the second washing machine via the second conduit and the fourth conduit and to operate independent of any control circuitry of the first washing machine or the second washing machine, the control circuitry being configured to control operation of the first washing machine and the second washing machine.

22. The system of claim 21 further comprising:
a second laundry fluid reservoir;
a fifth conduit connecting the second laundry fluid reservoir to the laundry fluid delivery controller; and
a sixth conduit connecting the laundry fluid delivery controller to the first washing machine;
wherein the laundry fluid delivery controller is configured to pump a second laundry fluid from the second laundry fluid reservoir to the first washing machine via the fifth conduit and the sixth conduit.

23. The system of claim 21 wherein the third conduit is configured to deposit laundry fluid undiluted and directly into a tub of the first washing machine.

24. The system of claim 21 wherein the laundry fluid delivery controller comprises a first pump configured to draw laundry fluid from the first conduit and deliver the drawn laundry fluid to the third conduit.

25. The system of claim 21 wherein the reservoir is positioned elevationally below a tub of the washing machine thereby to preventing siphoning of the laundry fluid from the laundry fluid reservoir to washing machine tub when the pump is inactive.
